(19) United States
(12) Patent Application Publication
(10) Pub. No.: US 2026/0369144 A1
(43) Pub. Date: Nov. 19, 2026

(54) REGION MANAGEMENT SYSTEM

(71) Applicant: PIXART IMAGING INC., HSIN-CHU (TW)

(72) Inventor: SUNG-HAN WU, HSIN-CHU (TW)

(21) Appl. No.: 19/209,952

(22) Filed: May 16, 2025

(51) Int. Cl. G08B 13/196; G06V 20/52; G07C 9/28; H04N 7/18

(52) U.S. Cl. CPC G08B 13/19652; G06V 20/52; G07C 9/28; H04N 7/18

(57) ABSTRACT

A region management system is provided. The region management system includes a plurality of locators, at least one camera module and a controller. The locators are spaced apart from each other. The locators can jointly establish a signal region. The locators can receive a positioning signal from a positioning tag. The at least one camera module can monitor a portion of the signal region that is defined as a monitoring region. The controller is electrically coupled to the locators and the at least one camera module. The controller can detect the positioning signal generated by the positioning tag in the monitoring region through one of the locators, so as to control the at least one camera module to perform an identification action.

### FIELD OF THE DISCLOSURE

The present disclosure relates to a system, and more particularly to a region management system.

### BACKGROUND OF THE DISCLOSURE

A conventional region management system determines the location of personnel within an indoor environment by coordinating locators, positioning tags, and a controller. Specifically, the locators are disposed in predetermined positions within the indoor environment to detect signals transmitted by the positioning tags, and the controller processes the received signals to determine the corresponding location of the personnel carrying the positioning tags.

However, the conventional region management system is only capable of identifying the location of the personnel configured with the positioning tag and cannot further obtain other information regarding the personnel. As a result, the system lacks the capability to provide real-time monitoring of personnel status, such as body movements and identity confirmation. The limitation reduces the system's applicability in environments requiring enhanced personnel tracking, such as healthcare facilities, industrial sites, and security-sensitive areas, where obtaining additional personnel-related information is critical for operational efficiency, safety, and management decision-making.

Accordingly, there remains a need for an improved region management system that not only determines personnel location but also provides additional personnel-related information to enhance monitoring and management capabilities.

### SUMMARY OF THE DISCLOSURE

In response to the above-referenced technical inadequacy, the present disclosure provides a region management system.

In order to solve the above-mentioned problems, one of the technical aspects adopted by the present disclosure is to provide a region management system. The region management system includes a plurality of locators, a positioning tag, at least one camera module, and a controller. The locators are spaced apart from each other. The locators are configured to jointly establish a signal region. The locators are configured to receive a positioning signal from a positioning tag. The at least one camera module is configured to monitor a portion of the signal region that is defined as a monitoring region. The controller is electrically coupled to the locators and the at least one camera module. The controller is configured to detect the positioning signal generated by the positioning tag in the monitoring region through one of the locators, so as to control the at least one camera module to perform an identification action.

In one of the possible or preferred embodiments, a quantity of the at least one camera module is two, and the two camera modules are defined as a first camera module and a second camera module. The first camera module is configured to monitor a first sub-monitoring region of the monitoring region, and the second camera module is configured to monitor a second sub-monitoring region of the monitoring region that is located on one side of the first sub-monitoring region. When the controller detects the positioning signal generated by the positioning tag in the first sub-monitoring region through one of the locators, the controller controls the first camera module to perform a first sub-identification action of the identification action. When the controller detects the positioning signal generated by the positioning tag in the second sub-monitoring region through one of the locators, the controller controls the second camera module to perform a second sub-identification action of the identification action.

In one of the possible or preferred embodiments, the first sub-identification action is configured to confirm a legitimacy of the positioning signal in the first sub-monitoring region through at least one of a facial recognition, a gesture detection, or a motion detection, so as to send a notification. The second sub-identification action is configured to confirm a legitimacy of the positioning signal in the second sub-monitoring region through at least one of a facial recognition, a gesture detection, or a motion detection, so as to send a notification.

In one of the possible or preferred embodiments, a quantity of the at least one camera module is two, and the two camera modules are defined as a first camera module and a second camera module. The first camera module is configured to monitor a first sub-monitoring region of the monitoring region, and the second camera module is configured to monitor a second sub-monitoring region of the monitoring region. The first sub-monitoring region is surrounded by the second sub-monitoring region. When the controller detects the positioning signal generated by the positioning tag in the second sub-monitoring region through one of the locators and detects that a moving image is in the second sub-monitoring region through the second camera module, the first camera module is awakened by the controller to monitor the first sub-monitoring region.

In one of the possible or preferred embodiments, a photographing range of the second camera module is greater than a photographing range of the first camera module, and the photographing range of the first camera module is covered by the photographing range of the second camera module. A portion of the photographing range of the second camera module that does not overlap with the first camera module is defined as the second sub-monitoring region.

In one of the possible or preferred embodiments, the controller is configured to detect the positioning signal generated by the positioning tag in the monitoring region through one of the locators, so as to control each of the locators to switch from a normal power mode to a low power mode and to obtain a current position of the positioning tag through an image in the monitoring region.

In one of the possible or preferred embodiments, a quantity of the at least one camera module is two, and the two camera modules are defined as a first camera module and a second camera module. The first camera module is configured to monitor a first sub-monitoring region of the monitoring region, and the second camera module is configured to monitor a second sub-monitoring region of the monitoring region. The first sub-monitoring region is surrounded by the second sub-monitoring region, wherein, when the controller detects the current position of the positioning tag entering the second sub-monitoring region from the first sub-monitoring region, the controller controls each of the locators to switch from the low power mode to the normal power mode.

In one of the possible or preferred embodiments, when the controller detects an abnormal signal that is unable to be verified by the identity verification of a corresponding one of the locators located in the signal region, the controller is configured to send a notification.

In one of the possible or preferred embodiments, when the controller detects a moving object within the monitoring region by the at least one camera module and the controller receives no signals from the locators, the controller is configured to send a notification.

In order to solve the above-mentioned problems, another one of the technical aspects adopted by the present disclosure is to provide a region management system. The region management system includes a plurality of locators, at least one camera module, and a controller. The locators are spaced apart from each other. The locators are configured to jointly establish a signal region. The at least one camera module is configured to monitor a portion of the signal region that is defined as a monitoring region. The controller is electrically coupled to the locators and the at least one camera module. When the controller receives a trigger signal from the at least one camera module, the controller performs a warning action.

In one of the possible or preferred embodiments, the warning action includes at least one of issuing an alert notification, recording an image, or providing behavioral recommendations.

In one of the possible or preferred embodiments, when the at least one camera module detects at least one of a moving object or an error action in the monitoring region, the at least one camera module is configured to send the trigger signal to the controller.

In one of the possible or preferred embodiments, a quantity of the at least one camera module is two, and the two camera modules are configured to jointly monitor the monitoring region.

In one of the possible or preferred embodiments, a quantity of the at least one camera module is two, and the two camera modules are defined as a first camera module and a second camera module. The first camera module is configured to monitor a first sub-monitoring region of the monitoring region, and the second camera module is configured to monitor a second sub-monitoring region of the monitoring region that is located on one side of the first sub-monitoring region. When the controller receives a first sub-trigger signal of the trigger signal generated by the first camera module, the controller performs the warning action. When the controller receives a second sub-trigger signal of the trigger signal generated by the second camera module, the controller performs the warning action.

In one of the possible or preferred embodiments, a quantity of the at least one camera module is two, and the two camera modules are defined as a first camera module and a second camera module. The first camera module is configured to monitor a first sub-monitoring region of the monitoring region, and the second camera module is configured to monitor a second sub-monitoring region of the monitoring region. The first sub-monitoring region is surrounded by the second sub-monitoring region. When the controller receives the trigger signal from the second camera module, the first camera module is awakened by the controller to monitor the first sub-monitoring region.

In one of the possible or preferred embodiments, a photographing range of the second camera module is greater than a photographing range of the first camera module, and the photographing range of the first camera module is covered by the photographing range of the second camera module. A portion of the photographing range of the second camera module that does not overlap with the first camera module is defined as the second sub-monitoring region.

In one of the possible or preferred embodiments, when the controller receives that the trigger signal has been present for a predetermined duration, the controller performs the identification action.

In order to solve the above-mentioned problems, yet another one of the technical aspects adopted by the present disclosure is to provide a region management system. The region management system includes a plurality of locators, at least one camera module, and a controller. The locators are spaced apart from each other. The locators are configured to jointly establish a signal region. The at least one camera module is configured to monitor a portion of the signal region that is defined as a monitoring region. The controller is electrically coupled to the locators and the at least one camera module. The controller is configured to detect a plurality of signals generated by a plurality of positioning tags that are located in the monitoring region, so as to control the at least one camera module to switch among a plurality of alarm modes according to at least one of a quantity or types of the signals.

In one of the possible or preferred embodiments, when the controller detects the quantity of the signals exceeds a quantity threshold, the controller controls the at least one camera module to switch to one of the alarm modes that is defined a regional segmentation mode. When the at least one camera module is in the regional segmentation mode, the at least one camera module divides the monitoring region into at least one alarm sub-region and at least one of standby sub-region, and issues an alarm when any of the signals is located within the at least one alarm sub-region.

In one of the possible or preferred embodiments, when the controller detects the type of one of the signals is unauthorized, the controller controls the at least one camera module to switch to one of the alarm modes that is defined a tracking mode. When the at least one camera module is in the tracking mode, the at least one camera module issues an alarm upon detecting that one of the positioning tags sending an unauthorized signal has been present in the monitoring region for longer than a time threshold.

Therefore, in the region management system provided by the present disclosure, by virtue of “the at least one camera module being configured to monitor a portion of the signal region that is defined as a monitoring region,” and “the controller being configured to detect the positioning signal generated by the positioning tag in the monitoring region through one of the locators, so as to control the at least one camera module to perform an identification action,” the region management system can be obtain information other than the location to perform other actions.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic circuit block diagram of a region management system according to a first embodiment of the present disclosure;

FIG. 2 is a schematic view of the region management system according to the first embodiment of the present disclosure in a practical application;

FIG. 3 is a schematic view of an identity verification matching between a positioning signal generated by a positioning tag and a plurality of locators according to the first embodiment of the present disclosure;

FIG. 4 is a schematic view of another scenario of the practical application of FIG. 2.

FIG. 5 is a schematic view of an identity verification mismatch between a positioning signal generated by a positioning tag and a corresponding one of a plurality of locators according to the first embodiment of the present disclosure;

FIG. 6 is a schematic view of a controller recording the medication retrieval behavior through a camera module according to the first embodiment of the present disclosure;

FIG. 7 is a schematic view of yet another scenario of the practical application of FIG. 2;

FIG. 8 is a schematic view of the controller verifying that both the positioning signal and the facial feature are matched according to the first embodiment of the present disclosure;

FIG. 9 is a schematic view of the controller recording the medication retrieval behavior and personnel identity through the camera module according to the first embodiment of the present disclosure;

FIG. 10 is a schematic view of the region management system according to the first embodiment of the present disclosure in another practical application;

FIG. 11 is a schematic view of another scenario of the practical application of FIG. 10.

FIG. 12 is a schematic view of the region management system according to the first embodiment of the present disclosure in yet another practical application;

FIG. 13 is a schematic view of the region management system according to the first embodiment of the present disclosure in still another practical application;

FIG. 14 is a schematic view of the controller verifying that the facial feature is mismatched according to the first embodiment of the present disclosure;

FIG. 15 is a schematic circuit block diagram of a region management system according to a second embodiment of the present disclosure; and

FIG. 16 is a schematic view of the region management system according to a third embodiment of the present disclosure in a practical application.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

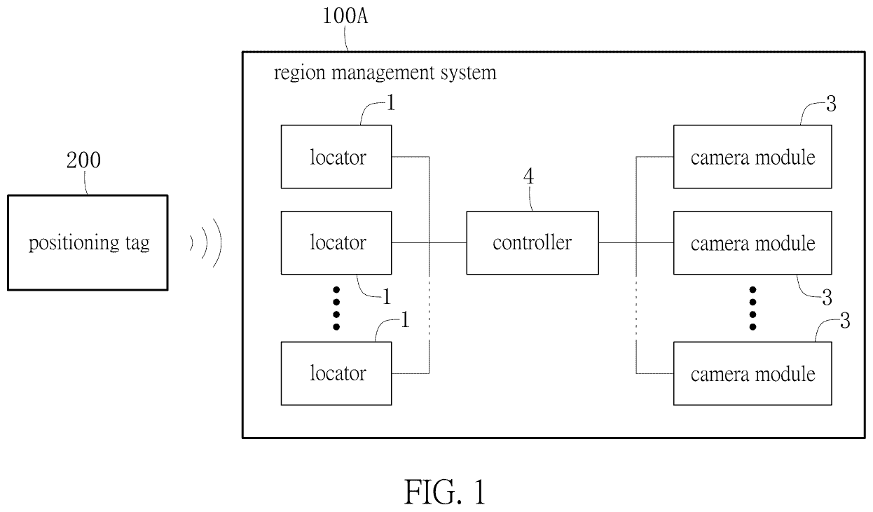

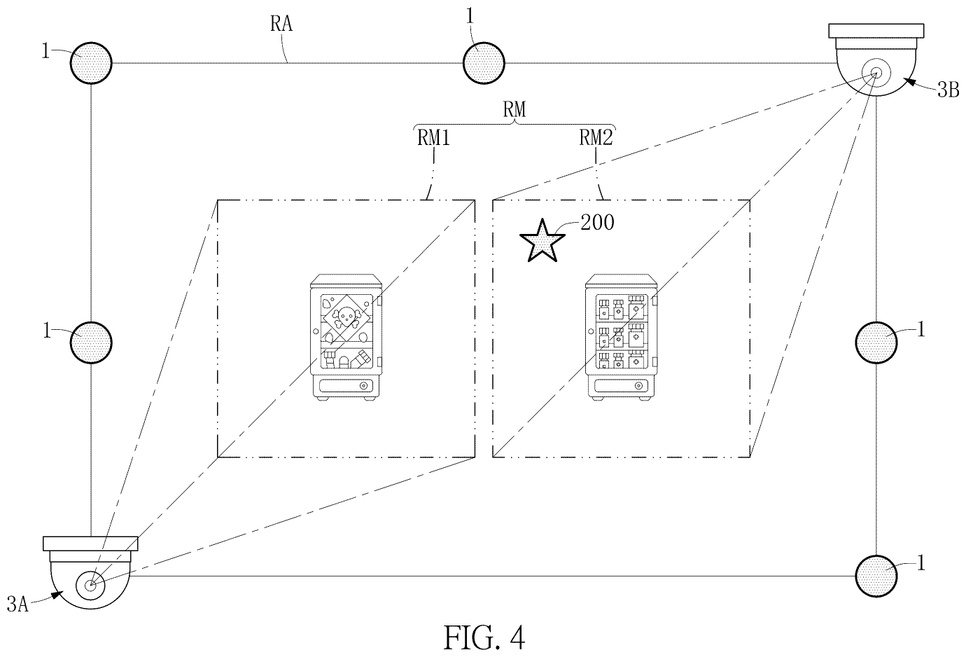

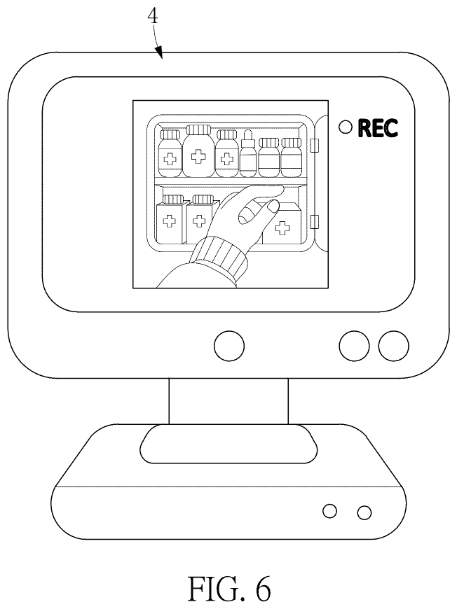

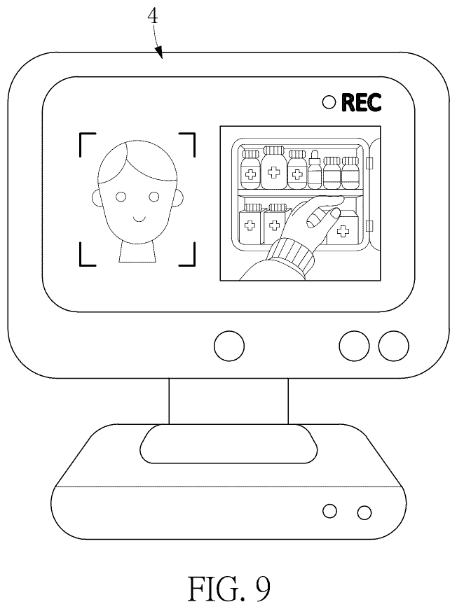

Referring to FIG. 1 to FIG. 13, a first embodiment of the present disclosure provides a region management system 100A. As shown in FIG. 1, the region management system 100A includes a plurality of locators 1, at least one camera module (e.g., 3, 3A or 3B), and a controller 4.

The locators 1 are disposed in a predetermined space (e.g., a medicine room) and are spaced apart from each other. In practice, the locators 1 each have a signal range, and the locators 1 are positioned to completely cover the predetermined space, so that the locators 1 can jointly establish a signal region RA. Accordingly, the locators 1 can perform signal transmission to and signal reception from a positioning tag 200 within the signal region.

It should be noted that the locators 1 and the positioning tag 200 use the same communication protocol, such as Ultra-Wideband (i.e., UWB), Bluetooth, Angle of Arrival (i.e., AOA), Global Positioning System (i.e., GPS), or Wireless Fidelity (i.e., Wi-Fi). Additionally, the positioning tag 200 includes identity data configured to be recognized by the locators 1, so that when the locators 1 communicate with the positioning tag 200, the locators 1 can confirm an identity of the positioning tag 200.

For example, when the monitoring personnel mistakenly wears the positioning tag 200 that is unmatched and enters the signal region, the locators 1 identify that the monitoring personnel located in the signal region is unauthorized through the identity data.

In other words, the positioning tag 200 can generate a positioning signal that matches an identity verification of a corresponding one of the locators 1, so as to be received by at least one of the locators 1.

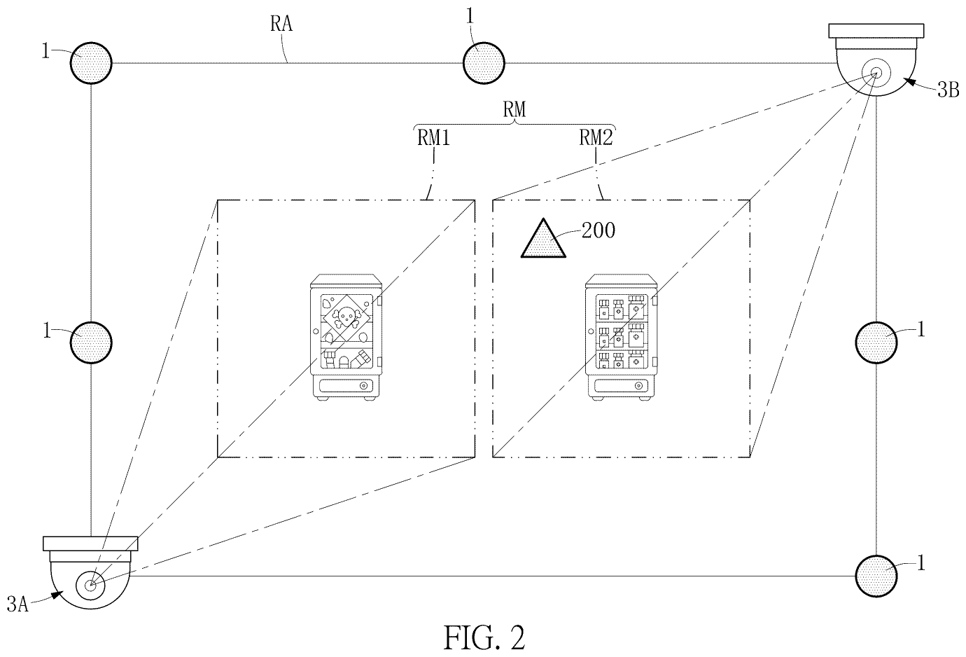

Referring to FIG. 2, the at least one camera module can monitor a portion of the signal region RA that is defined as a monitoring region RM.

Specifically, when a region requiring behavior recognition (e.g., a controlled drug region in the medicine room) exists within the predetermined space covered by the signal region RA, the at least one camera module is disposed to monitor the region where the behavior recognition is required (i.e., the portion of the signal region RA), but the present disclosure is not limited thereto.

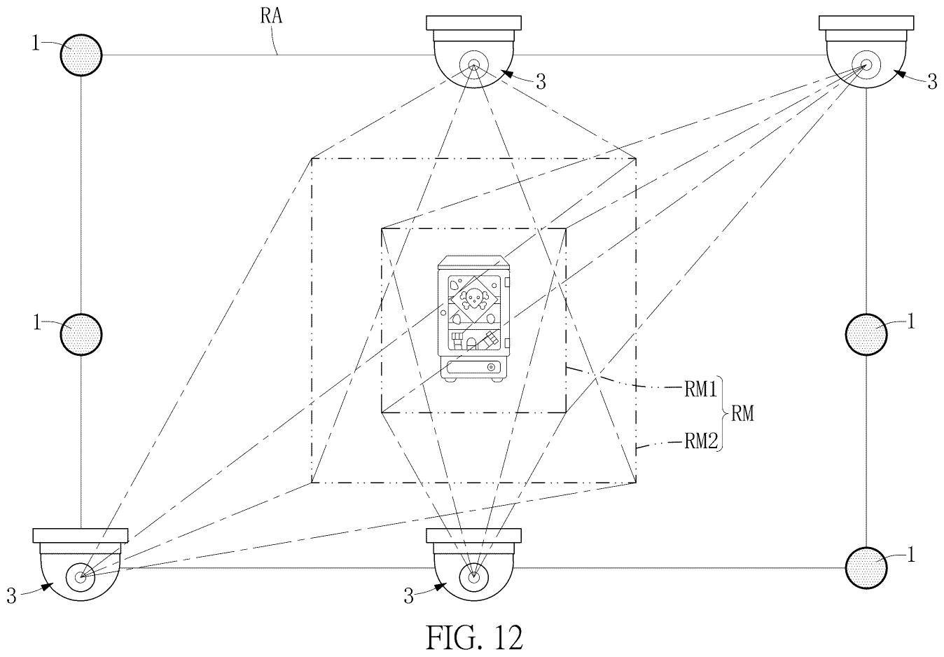

For example, when the entire predetermined space covered by the signal region requires behavioral action identification, a quantity of the at least one camera module may be a plurality, and the plurality of camera modules 3 can jointly monitor the entire signal region RA (as shown in FIG. 2 and FIG. 12).

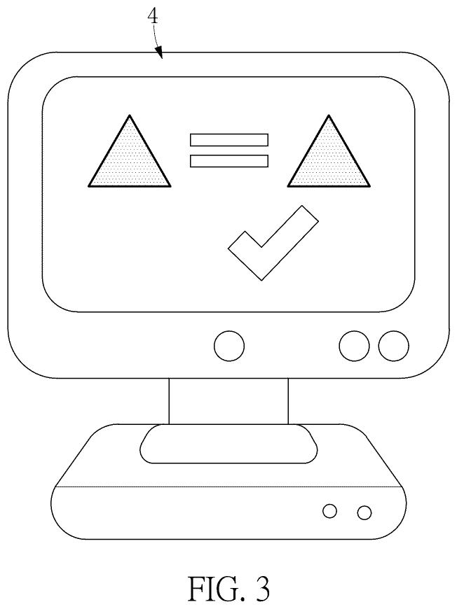

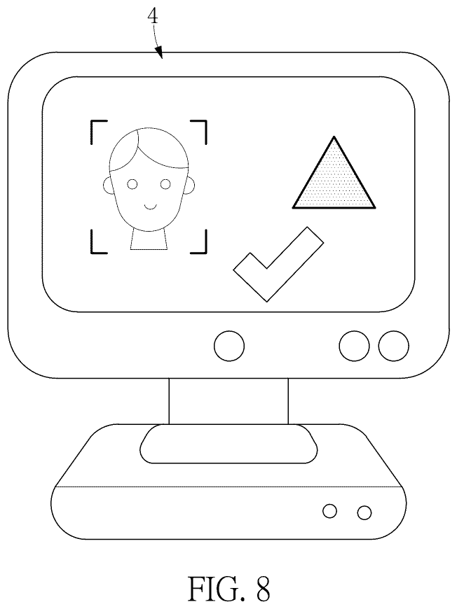

Referring to FIG. 2, FIG. 3 and FIG. 8, the controller 4 can collect data via the locators 1 and the at least one camera module to monitor the monitoring personnel wearing the positioning tag 200. Specifically, the controller 4 is electrically coupled to the locators 1 and the at least one camera module, and the controller 4 can detect the positioning signal generated by the positioning tag 200 in the monitoring region RM through one of the locators 1, so as to control the at least one camera module to perform an identification action. In practice, the identification action can be facial feature recognition, behavior recognition, or the like.

In one of the embodiments, as shown in FIG. 2, the monitoring region RM can be divided into two sub-regions that are two independent regions, the region management system 100A perform different identification actions in different sub-regions, and the identification actions triggered in the two sub-regions are two separate events that do not affect each other.

In this case, a quantity of the at least one camera module is two. For ease of subsequent description, the two camera modules 3 are respectively defined as a first camera module 3A and a second camera module 3B.

The first camera module 3A can monitor a first sub-monitoring region RM1 of the monitoring region, and the second camera module 3B can monitor a second sub-monitoring region RM2 of the monitoring region RM that is located on one side of the first sub-monitoring region RM1. That is, the monitoring region RM is divided into the first sub-monitoring region RM1 and second sub-monitoring region RM2 that are adjacent to each other.

When the controller 4 detects the positioning signal generated by the positioning tag 200 in the first sub-monitoring region RM1 through one of the locators 1, the controller 4 controls the first camera module 3A to perform a first sub-identification action of the identification action. Moreover, when the controller 4 detects the positioning signal generated by the positioning tag 200 in the second sub-monitoring region RM2 through one of the locators 1, the controller 4 controls the second camera module 3B to perform a second sub-identification action of the identification action. Moreover, the controller 4 may also activate the camera module corresponding to the location of the locators 1 that received the positioning signal (e.g., the first sub-monitoring region RM1 or the second sub-monitoring region RM2), so as to monitor the location corresponding to the aforementioned locators 1 that received the positioning signal.

Preferably, the first sub-identification action can confirm a legitimacy of the positioning signal in the first sub-monitoring region RM1 through at least one of a bio sensing (e.g., facial recognition), a gesture detection, or a motion detection, so as to send a notification. Moreover, the second sub-identification action can confirm a legitimacy of the positioning signal in the second sub-monitoring region RM2 through at least one of a bio sensing (e.g.,. facial recognition), a gesture detection, or a motion detection, so as to send a notification.

For example, as shown in FIG. 2, the controlled drug region (i.e., the monitoring region RM) is classified based on addiction levels into a first-level control region (i.e., the first sub-monitoring region RM1) and a second-level control region (i.e., the second sub-monitoring region RM2). Among them, the first-level control region requires dual identity verification and records the medication retrieval behavior, and the second-level control region requires simple identity verification and records the medication retrieval behavior.

In the example, as shown in FIG. 2 to FIG. 6, when a personnel wearing the positioning tag 200 enters the second-level control region, the controller 4 detects whether the positioning signal generated by the positioning tag 200 located in the second-level control region matches the identity verification of the corresponding one of the locators (e.g., one of the locators adjacent to the second sub-monitoring region RM2) to confirm the identity. Additionally, the controller 4 controls the second camera module 3B to record and analyze a movement images of the personnel within the second-level control region to determine whether the behavior corresponds to medication retrieval.

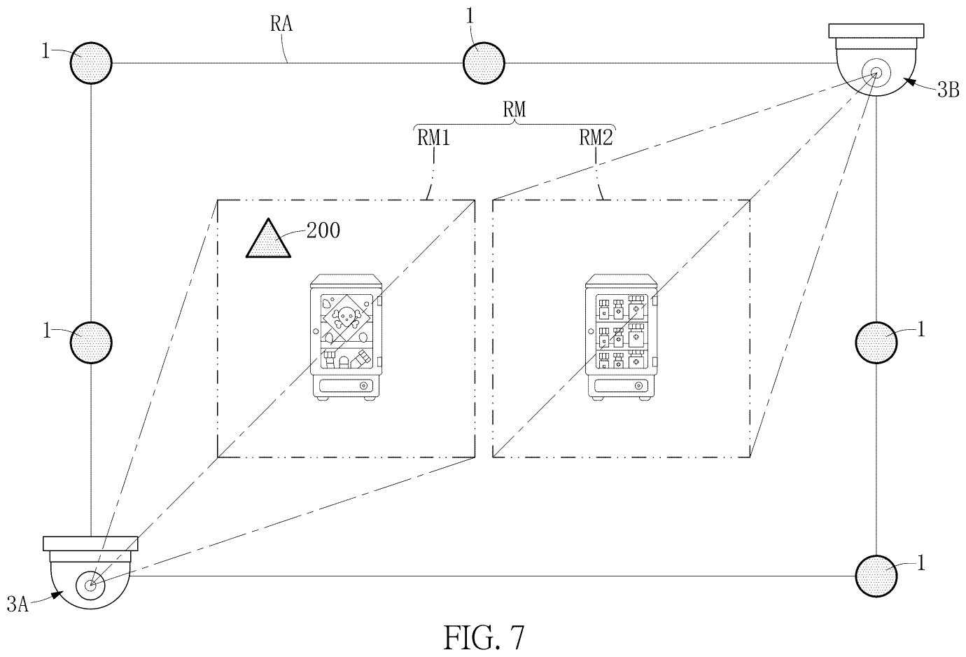

Similarly, as shown in FIG. 7 to FIG. 9, when the personnel wearing the positioning tag 200 enters the first-level control region, the controller 4 not only performs a first identity verification based on whether the positioning signal matches the identity verification but also controls the first camera module 3A to record and recognize a facial feature of the personnel within the first-level control region to determine whether the facial feature match an authorized facial list (i.e., second identity verification). Furthermore, the controller 4 controls the first camera module 3A to record and analyze a movement images of the personnel within the first-level control region to determine whether the behavior corresponds to medication retrieval.

In practice, when the controller 4 fails to match an identity during identification, the controller 4 may output a notification and record an image. Naturally, the controller 4 may also be configured to control the controlled drug cabinet to be closed or locked.

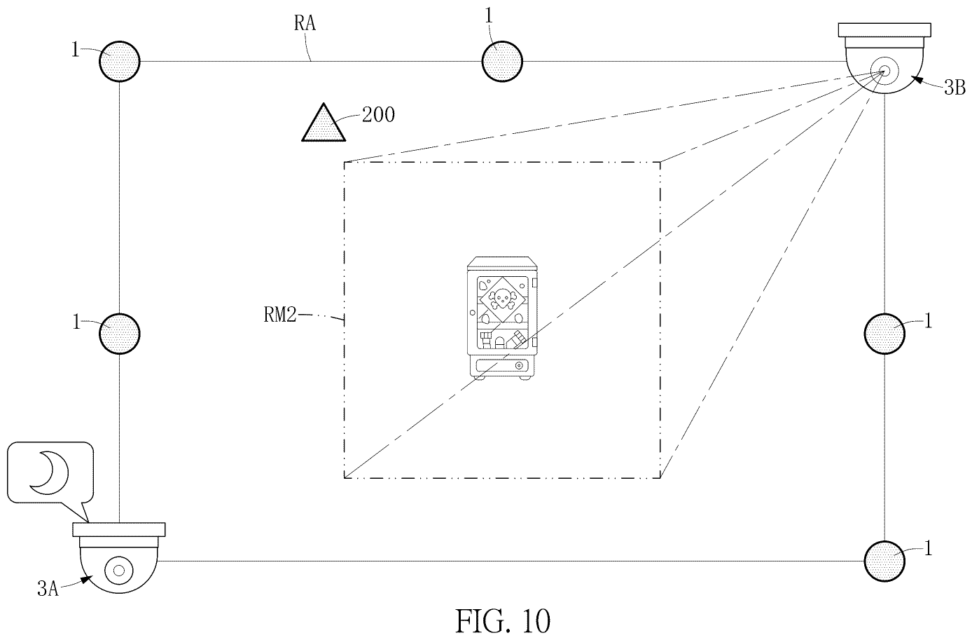

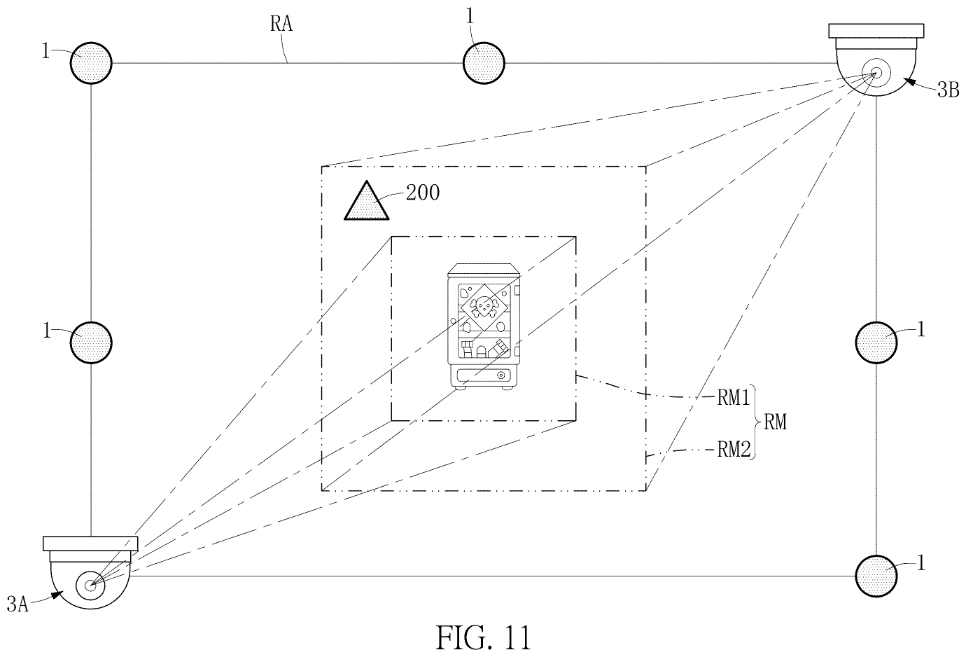

In another one of the embodiments, as shown in FIG. 10 and FIG. 11, the monitoring region RM can be divided into two sub-regions that are two associated regions, the region management system 100A perform different identification actions in different sub-regions, and the identification actions triggered in the two sub-regions are two interconnected events.

Specifically, the first sub-monitoring region RM1 is surrounded by the second sub-monitoring region RM2. That is, when the person enters the first sub-monitoring region RM1, the personnel must pass through the second sub-monitoring region RM2. In practical applications, the first sub-monitoring region RM1 can be understood as a controlled region (e.g., a predetermined region where the controlled drug cabinet is located), and the second sub-monitoring region RM2 can be understood as a warning region (e.g., a surrounding region of the predetermined region).

Additionally, a quantity of the at least one camera module is two. For ease of subsequent description, the two camera modules 3 are respectively defined as a first camera module 3A and a second camera module 3B.

The first camera module 3A can monitor a first sub-monitoring region RM1 of the monitoring region RM, and the second camera module 3B can monitor a second sub-monitoring region RM2 and the first sub-monitoring region RM1 of the monitoring region RM.

In practice, a shooting range of the second camera module 3B is larger than a shooting range of the first camera module 3A, and the shooting range of the first camera module 3A is covered by the shooting range of the second camera module 3B. Moreover, a part of the shooting range of the second camera module 3B that does not overlap with the first camera module is defined as the second sub-monitoring region RM2.

When the controller 4 detects the positioning signal generated by the positioning tag 200 in the second sub-monitoring region RM2 through one of the locators 1 and detects that a moving image is in the second sub-monitoring region RM2 through the second camera module 3B, the first camera module 3A is awakened by the controller 4 to monitor the first sub-monitoring region RM1 (as shown in FIG. 10 and FIG. 11). Naturally, the controller 4 may also adjust the wake-up mechanism according to power consumption and security control levels. Additionally, the sampling frequency and resolution of the first camera module 3A used to monitor higher-security regions may be higher than those of the second camera module 3B used to monitor lower-security regions.

In other words, the first camera module 3A is used to monitor the first sub-monitoring region RM1 and remains in a default sleep state, and the second camera module 3B is used to monitor the second sub-monitoring region RM2 (i.e., the periphery of the first sub-monitoring region RM1) and remains actively monitoring. The first sub-monitoring region RM1 is only activated for monitoring when the controller 4 detects that both of the following conditions are met: the positioning signal is within the second sub-monitoring region, and a moving object is detected.

Accordingly, the region management system 100A can effectively reduce energy consumption and prevent false notifications (e.g., misjudgment caused by an insect flying in front of the first camera module 3A).

Naturally, in other embodiments of the present disclosure (not shown), the quantity of sub-monitoring regions and the quantity of camera modules 3 can be correspondingly increased according to the designer's requirements. This allows for more refined hierarchical activation of regions, thereby significantly reducing false detections (as shown in FIG. 12).

In yet another one of the embodiments, the locators 1 can cooperate with the at least one camera module to maintain accurate positioning of personnel while reducing the update frequency of the locators, so as to achieve the requirement of lowering energy consumption.

Specifically, the controller 4 can detect the positioning signal generated by the positioning tag 200 in the monitoring region through one of the locators 1, so as to control each of the locators 1 to switch from a normal power mode to a low power mode and to obtain a current position of the positioning tag 200 through an image in the monitoring region RM.

In practice, when the locators 1 are in the low power mode, the locators 1 reduce the frequency of real-time updates of the positioning signal and utilize movement images within the monitoring region RM for positioning. That is, the controller 4 integrates both the positioning signal and movement images simultaneously to determine the location of the personnel.

Naturally, in the present embodiment, a quantity of the at least one camera module can also be a plurality, and the shooting ranges of the camera modules 3 can partially overlap to enhance positioning accuracy.

For ease of subsequent description, the quantity of the at least one camera module is exemplified as two, and the two camera modules 3 are respectively defined as a first camera module 3A and a second camera module 3B. The first camera module 3A can monitor a first sub-monitoring region RM1 of the monitoring region RM, the second camera module 3B can monitor a second sub-monitoring region RM2 and the first sub-monitoring region RM1 of the monitoring region RM, and the first sub-monitoring region RM1 is surrounded by the second sub-monitoring region RM2. That is, a photographing range of the second camera module is greater than a photographing range of the first camera module, and the photographing range of the first camera module is covered by the photographing range of the second camera module 3B.

In the example, the region where the photographing range of the second camera module 3B overlaps with the photographing range of the first camera module is defined as the first sub-monitoring region RM1, while the region where the photographing range of the second camera module 3B does not overlap with the photographing range of the first camera module is defined as the second sub-monitoring region RM2. When the controller 4 detects that the positioning signal (i.e., the current position of the positioning tag 200) has entered the first sub-monitoring region RM1 or the second sub-monitoring region RM2, the controller 4 controls each of the locators 1 to switch from the normal power mode to the low power mode. However, the present disclosure is not limited thereto.

In another example, the controller 4 can switch a part of the locators from the normal power mode to the low power mode when the positioning signal enters the second sub-monitoring region RM2. When the controller 4 detects that the positioning signal has entered the first sub-monitoring region RM1 from the second sub-monitoring region RM2, the controller 4 switches all the locators from the normal power mode to the low power mode.

Similarly, the controller 4 can also switch all the locators 1 from the normal power mode to the low power mode when the positioning signal enters the first sub-monitoring region RM1. Conversely, when the controller 4 detects that the current position of the positioning tag 200 has entered the second sub-monitoring region RM2 from the first sub-monitoring region RM1, the controller 4 controls each of the locators 1 to switch from the low power mode to the normal power mode.

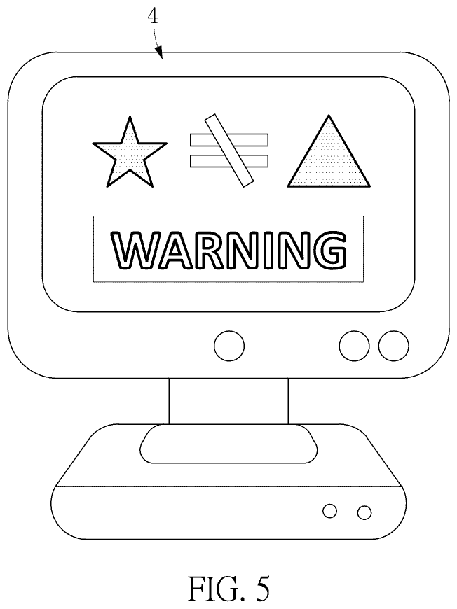

It is worth noting that the personnel in different controlled regions are assigned positioning tags with different identity verifications. When the personnel mistakenly enter an unauthorized controlled region, the region management system 100A can issue an alert in real time. Specifically, when the controller 4 detects, via the locators 1, an unauthorized signal generated by the positioning tag 200 (i.e., an abnormal signal that is unable to be verified by the identity verification of a corresponding one of the locators 1 located in the signal region), the controller 4 can send a notification (as shown in FIG. 5).

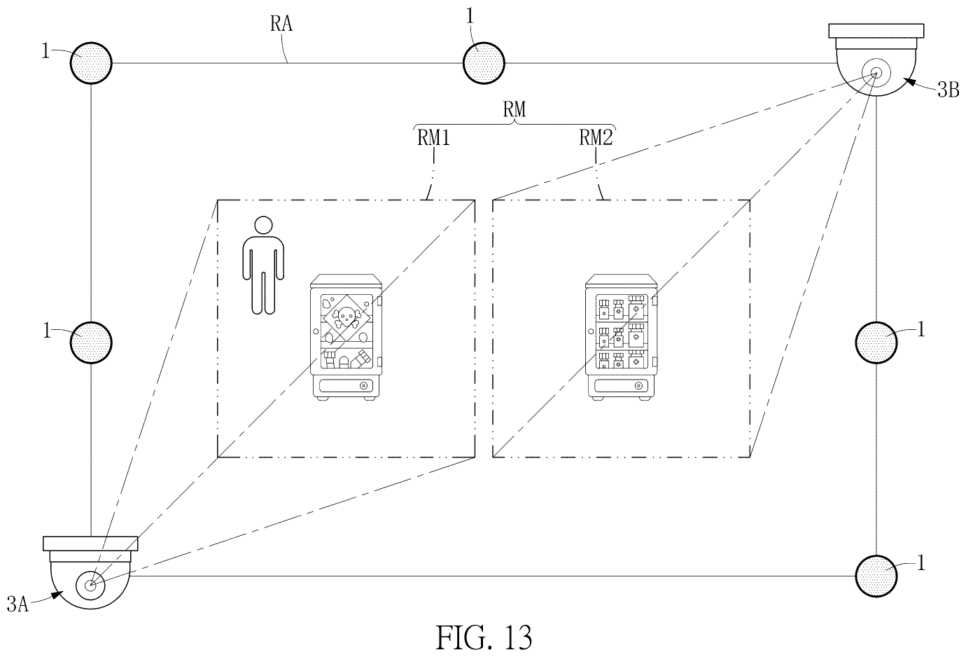

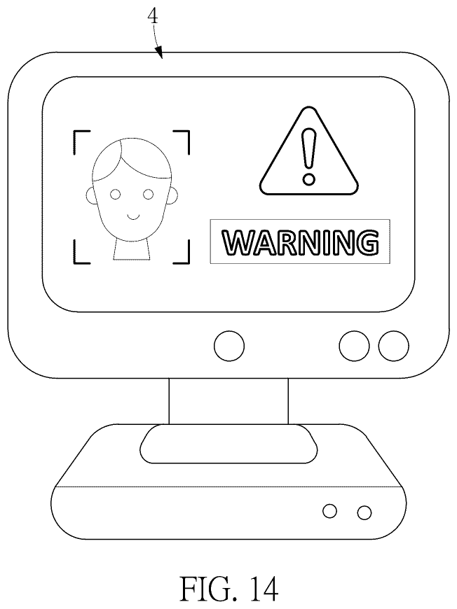

In another scenario, when the personnel without an assigned the positioning tag 200 enters the monitoring region RM, the region management system 100A can also detect the personnel in real time (as shown in FIG. 13 and FIG. 14).

### Second Embodiment

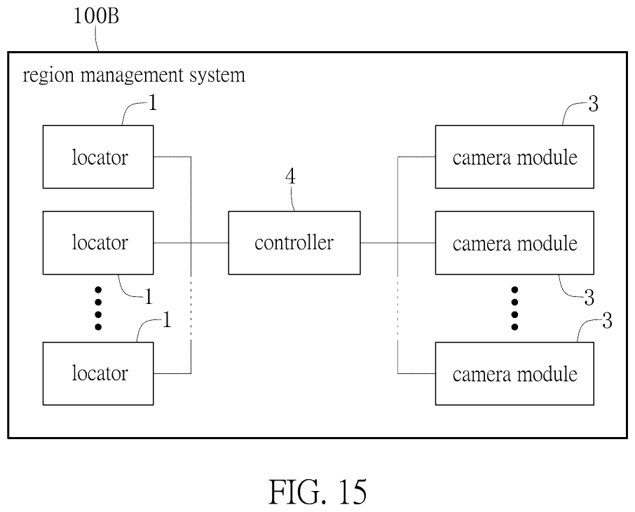

Referring to FIG. 15, a second embodiment of the present disclosure provides a region management system 100B. The present embodiment is similar to the first embodiment, and the similarities there-between will not be repeated herein. The difference between the present embodiment and the first embodiment mainly resides in that the region management system 100B omits the positioning tag. In other words, in the present embodiment, the region management system 100B performs monitoring and management within the signal region without relying on a positioning signal.

Specifically, when the controller 4 detects a moving object within the monitoring region RM by the at least one camera module and receives no signals from the locators, the controller 4 can send a notification.

On the other hand, in the present disclosure, when the controller 4 receives a trigger signal from the at least one camera module, the controller 4 performs a warning action. That is to say, the controller 4 can issue the warning action when no positioning signal is received within the signal region RA and the trigger signal is detected.

In practice, the at least one camera module can generate the trigger signal to the controller 4 when the at least one camera module detects at least one of a moving object or an error action within the monitoring region. Moreover, the warning action includes at least one of issuing an alert notification, recording an image, or providing behavioral recommendations.

Preferably, to accurately determine the personnel's location within the monitoring region RM, a quantity of the at least one camera module can be a plurality, and the photographing ranges of the camera modules 3 overlap each other. For example, when the quantity of the at least one camera module is two, the two camera modules 3 can be positioned at 0-degree and 90-degree orientations, respectively, and the two camera modules 3 can jointly monitor the monitoring region.

In the present embodiments, the region management system 100B can divide the monitoring region RM into two sub-regions that are two independent regions, the region management system 100B perform different identification actions in different sub-regions, and the identification actions triggered in the two sub-regions are two separate events that do not affect each other.

Specifically, a quantity of the at least one camera module is two, and the two camera modules 3 are defined as a first camera module 3A and a second camera module 3B. The first camera module 3A can monitor a first sub-monitoring region RM1 of the monitoring region RM, and the second camera module 3B can monitor a second sub-monitoring region RM2 of the monitoring region RM that is located on one side of the first sub-monitoring region RM1. When the controller 4 receives a first sub-trigger signal of the trigger signal generated by the first camera module 3A, the controller 4 performs the warning action. When the controller 4 receives a second sub-trigger signal of the trigger signal generated by the second camera module 3B, the controller 4 performs the warning action.

Moreover, the first camera module 3A and the second camera module 3B can cooperate with each other to achieve the requirement of lowering energy consumption.

In detail, the second sub-monitoring region RM2 monitored by the second camera module 3B is designed to surround the first sub-monitoring region RM1 monitored by the first camera module 3A. That is, a photographing range of the second camera module 3B is greater than a photographing range of the first camera module 3A, and the photographing range of the first camera module 3A is covered by the photographing range of the second camera module 3B. Additionally, the first camera module 3A remains in a default sleep state, and when the controller 4 receives the trigger signal from the second camera module 3B, the controller 4 awakens the first camera module 3A to monitor the first sub-monitoring region RM1.

Naturally, the controller 4 can also be configured with a predetermined duration. When the controller 4 detects that the trigger signal has been present for the predetermined duration, the controller 4 performs the identification action. Accordingly, the controller 4 can reduce false detections.

### Third Embodiment

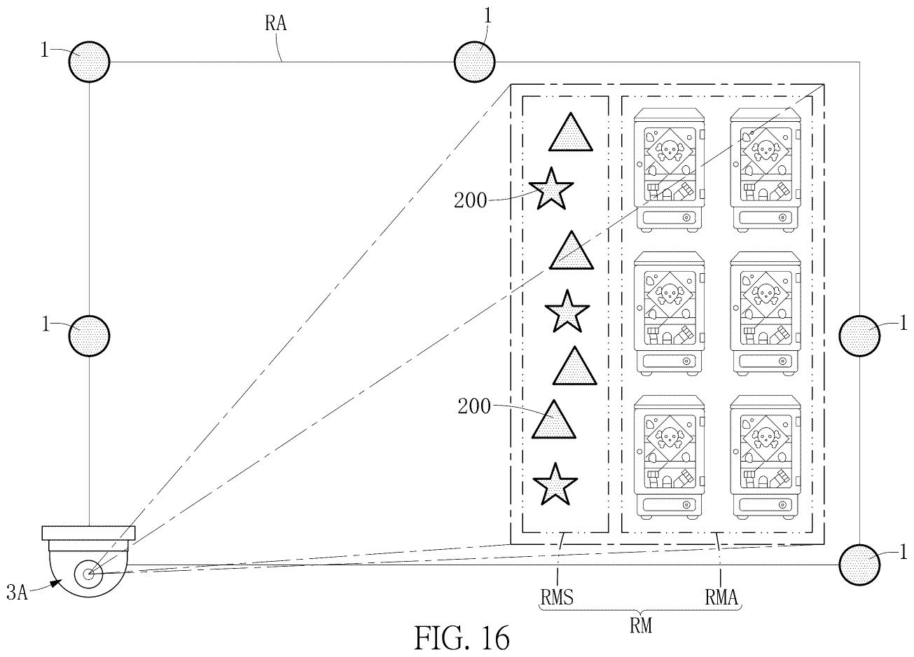

Referring to FIG. 16, a third embodiment of the present disclosure provides a region management system. The present embodiment is similar to the second embodiment, and the similarities there-between will not be repeated herein. The difference between the present embodiment and the second embodiment mainly resides in that the controller 4 can detect a plurality of signals generated by a plurality of positioning tags that are located in the monitoring region RM, so as to control the at least one camera module to switch among a plurality of alarm modes according to at least one of a quantity or types of the signals.

In one of the embodiments, when the controller 4 detects the quantity of the signals exceeds a quantity threshold, the controller 4 controls the at least one camera module to switch to one of the alarm modes that is defined a regional segmentation mode. Moreover, when the at least one camera module is in the regional segmentation mode, the at least one camera module divides the monitoring region RM into at least one alarm sub-region RMA and at least one of standby sub-region RMS, and issues an alarm when any of the signals is located within the at least one alarm sub-region RMA.

For example, when the monitoring region RM includes a corridor and a controlled drug cabinet, and multiple personnel carrying the positioning tags pass through the corridor, the controller 4 controls the at least one camera module to switch to regional segmentation mode based on the quantity threshold (e.g., five people). In the present mode, the at least one camera module defines the area corresponding to the corridor as a standby sub-region RMS and the area corresponding to the controlled drug cabinet as an alarm sub-region RMA for monitoring. Accordingly, the region management system will not issue false alarms simply due to a large number of personnel passing through the monitoring region.

In another one of the embodiments, when the controller 4 detects the type of one of the signals is unauthorized, the controller 4 controls the at least one camera module to switch to one of the alarm modes that is defined a tracking mode. When the at least one camera module is in the tracking mode, the at least one camera module issues an alarm upon detecting that one of the positioning tags sending an unauthorized signal has been present in the monitoring region RM for longer than a time threshold.

For example, when the controller 4 detects that an unauthorized personnel (i.e., a person carrying an unauthorized positioning tag) has mistakenly entered the monitoring region, the controller 4 controls the at least one camera module to switch to tracking mode, enabling the at least one camera module to track the image of the unauthorized personnel based on one of the positioning tags sending an unauthorized signal.

When the controller 4 detects, via the at least one camera module, that the unauthorized personnel has remained in the monitoring region beyond a specified duration (i.e., a time threshold), the controller 4 can issue an alert through the at least one camera module to initiate an eviction or a warning notification.

### Beneficial Effects of the Embodiments

In conclusion, in the region management system provided by the present disclosure, by virtue of “the at least one camera module being configured to monitor a portion of the signal region that is defined as a monitoring region,” and “the controller being configured to detect the positioning signal generated by the positioning tag in the monitoring region through one of the locators, so as to control the at least one camera module to perform an identification action,” the region management system can be obtain information other than the location to perform other actions.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A region management system, comprising:
a plurality of locators spaced apart from each other, wherein the locators are configured to jointly establish a signal region, and the locators are configured to receive a positioning signal from a positioning tag;
at least one camera module configured to monitor a portion of the signal region that is defined as a monitoring region; and
a controller electrically coupled to the locators and the at least one camera module, wherein the controller is configured to detect the positioning signal generated by the positioning tag in the monitoring region through one of the locators, so as to control the at least one camera module to perform an identification action.

2. The region management system according to claim 1, wherein a quantity of the at least one camera module is two, and the two camera modules are defined as a first camera module and a second camera module; wherein the first camera module is configured to monitor a first sub-monitoring region of the monitoring region, and the second camera module is configured to monitor a second sub-monitoring region of the monitoring region that is located on one side of the first sub-monitoring region; wherein, when the controller detects the positioning signal generated by the positioning tag in the first sub-monitoring region through one of the locators, the controller controls the first camera module to perform a first sub-identification action of the identification action; and wherein, when the controller detects the positioning signal generated by the positioning tag in the second sub-monitoring region through one of the locators, the controller controls the second camera module to perform a second sub-identification action of the identification action.

3. The region management system according to claim 2, wherein the first sub-identification action is configured to confirm a legitimacy of the positioning signal in the first sub-monitoring region through at least one of a facial recognition, a gesture detection, or a motion detection, so as to send a notification; and wherein the second sub-identification action is configured to confirm a legitimacy of the positioning signal in the second sub-monitoring region through at least one of a facial recognition, a gesture detection, or a motion detection, so as to send a notification.

4. The region management system according to claim 1, wherein a quantity of the at least one camera module is two, and the two camera modules are defined as a first camera module and a second camera module; wherein the first camera module is configured to monitor a first sub-monitoring region of the monitoring region, and the second camera module is configured to monitor a second sub-monitoring region of the monitoring region; wherein the first sub-monitoring region is surrounded by the second sub-monitoring region; and wherein, when the controller detects the positioning signal generated by the positioning tag in the second sub-monitoring region through one of the locators and detects that a moving image is in the second sub-monitoring region through the second camera module, the first camera module is awakened by the controller to monitor the first sub-monitoring region.

5. The region management system according to claim 4, wherein a photographing range of the second camera module is greater than a photographing range of the first camera module, and the photographing range of the first camera module is covered by the photographing range of the second camera module; and wherein a portion of the photographing range of the second camera module that does not overlap with the first camera module is defined as the second sub-monitoring region.

6. The region management system according to claim 1, wherein the controller is configured to detect the positioning signal generated by the positioning tag in the monitoring region through one of the locators, so as to control each of the locators to switch from a normal power mode to a low power mode and to obtain a current position of the positioning tag through an image in the monitoring region.

7. The region management system according to claim 1, wherein a quantity of the at least one camera module is two, and the two camera modules are defined as a first camera module and a second camera module; wherein the first camera module is configured to monitor a first sub-monitoring region of the monitoring region, and the second camera module is configured to monitor a second sub-monitoring region of the monitoring region; wherein the first sub-monitoring region is surrounded by the second sub-monitoring region, and wherein, when the controller detects a current position of the positioning tag entering the second sub-monitoring region from the first sub-monitoring region, the controller controls each of the locators to switch from the low power mode to the normal power mode.

8. The region management system according to claim 1, wherein, when the controller detects an abnormal signal that is unable to be verified by the identity verification of a corresponding one of the locators located in the signal region, the controller is configured to send a notification.

9. The region management system according to claim 1, wherein, when the controller detects a moving object within the monitoring region by the at least one camera module and the controller receives no signals from the locators, the controller is configured to send a notification.

10. A region management system, comprising:
a plurality of locators spaced apart from each other, wherein the locators are configured to jointly establish a signal region;
at least one camera module configured to monitor a portion of the signal region that is defined as a monitoring region; and
a controller electrically coupled to the locators and the at least one camera module, wherein, when the controller receives a trigger signal from the at least one camera module, the controller performs a warning action.

11. The region management system according to claim 10, wherein the warning action includes at least one of issuing an alert notification, recording an image, or providing behavioral recommendations.

12. The region management system according to claim 10, wherein, when the at least one camera module detects at least one of a moving object or an error action in the monitoring region, the at least one camera module is configured to send the trigger signal to the controller.

13. The region management system according to claim 10, wherein a quantity of the at least one camera module is two, and the two camera modules are configured to jointly monitor the monitoring region.

14. The region management system according to claim 10, wherein a quantity of the at least one camera module is two, and the two camera modules are defined as a first camera module and a second camera module; wherein the first camera module is configured to monitor a first sub-monitoring region of the monitoring region, and the second camera module is configured to monitor a second sub-monitoring region of the monitoring region that is located on one side of the first sub-monitoring region; wherein, when the controller receives a first sub-trigger signal of the trigger signal generated by the first camera module, the controller performs the warning action; and
wherein, when the controller receives a second sub-trigger signal of the trigger signal generated by the second camera module, the controller performs the warning action.

15. The region management system according to claim 10, wherein a quantity of the at least one camera module is two, and the two camera modules are defined as a first camera module and a second camera module; wherein the first camera module is configured to monitor a first sub-monitoring region of the monitoring region, and the second camera module is configured to monitor a second sub-monitoring region of the monitoring region; wherein the first sub-monitoring region is surrounded by the second sub-monitoring region; and wherein, when the controller receives the trigger signal from the second camera module, the first camera module is awakened by the controller to monitor the first sub-monitoring region.

16. The region management system according to claim 15, wherein a photographing range of the second camera module is greater than a photographing range of the first camera module, and the photographing range of the first camera module is covered by the photographing range of the second camera module; and wherein a portion of the photographing range of the second camera module that does not overlap with the first camera module is defined as the second sub-monitoring region.

17. The region management system according to claim 10, wherein, when the controller receives that the trigger signal has been present for a predetermined duration, the controller performs the identification action.

18. A region management system, comprising:
a plurality of locators spaced apart from each other, wherein the locators are configured to jointly establish a signal region;
at least one camera module configured to monitor a portion of the signal region that is defined as a monitoring region; and
a controller electrically coupled to the locators and the at least one camera module, wherein the controller is configured to detect a plurality of signals generated by a plurality of positioning tags that are located in the monitoring region, so as to control the at least one camera module to switch among a plurality of alarm modes according to at least one of a quantity or types of the signals.

19. The region management system according to claim 18, wherein, when the controller detects the quantity of the signals exceeds a quantity threshold, the controller controls the at least one camera module to switch to one of the alarm modes that is defined a regional segmentation mode; and wherein, when the at least one camera module is in the regional segmentation mode, the at least one camera module divides the monitoring region into at least one alarm sub-region and at least one of standby sub-region, and issues an alarm when any of the signals is located within the at least one alarm sub-region.

20. The region management system according to claim 18, wherein, when the controller detects the type of one of the signals is unauthorized, the controller controls the at least one camera module to switch to one of the alarm modes that is defined a tracking mode; and wherein, when the at least one camera module is in the tracking mode, the at least one camera module issues an alarm upon detecting that one of the positioning tags sending an unauthorized signal has been present in the monitoring region for longer than a time threshold.
